(19) United States
(12) Patent Application Publication
(10) Pub. No.: US 2016/0380955 A1
(43) Pub. Date: Dec. 29, 2016

(54) WEB-BASED SOCIAL NETWORK

(71) Applicant: Alec Kremins, New Rochelle, NY (US)

(72) Inventor: Alec Kremins, New Rochelle, NY (US)

(21) Appl. No.: 15/191,048

(22) Filed: Jun. 23, 2016

Related U.S. Application Data
(60) Provisional application No. 62/183,365, filed on Jun. 23, 2015.

(51) Int. Cl. H04L 12/58; H04L 29/08

(52) U.S. Cl. CPC H04L 51/32; H04L 51/04; H04L 67/18; H04L 67/02; H04L 67/306; G06F 3/0481

(57) ABSTRACT

A user friendly web-based social network for conveniently finding and connecting to network members worldwide.

### CROSS-REFERENCE TO RELATED APPLICATIONS

This application claims the benefit of U.S. Provisional Application No. 62/183,365, filed Jun. 23, 2015, the entirety of which is hereby incorporated by reference.

### BACKGROUND

Internet, (i.e.,“web”)-based social networks are used to connect members of the network to one another and share information with one another. Data relating to the social network typically resides on a host server, and is accessible to its users through terminals such as personal computers, lap tops, tablets, smart phones and the like. Accessing a web based social network is typically achieved directly through a website associated with or dedicated to the social network or by using a software application installed on a user device that links via a web connection to the host server.

Existing social networking platforms fail to provide their users with certain capabilities and features that would be desirable in a web-based social network.

### SUMMARY

In general terms, this disclosure is directed to features of an interactive web-based social network.

In one aspect, a web-based social network system comprises a host server having a computer readable storage device storing instructions; a plurality of terminals, each of the plurality of terminals comprising at least one data input mechanism, a data processing device configured to control the terminal, and a dynamic and interactive graphical user interface; wherein data associated with members of the social network are stored on the host server and comprise a profile for each member, each profile comprising a geographic location associated with the member; wherein each of the plurality of terminals is configured to transmit data to and receive data from the host server; wherein the host server is configured to transmit data to a terminal associated with a first member of the social network; wherein the processing device executes the instructions and causes the graphical user interface of the terminal of the first member to display an interactive home screen, the interactive home screen comprising an image of a representation of a first portion of the Earth and configured to show at least one of a selectable first marker associated with a first geographic location and at least one of a selectable second marker associated with a second geographic location; wherein the first marker indicates that the first member is not connected with any members associated with the first geographic location; and wherein the second marker indicates that the first member is connected with at least one member associated with the second geographic location.

In another aspect, a computer implemented method for communicating between a first member of a social network and a second member of the social network comprises: receiving input from the first member selecting a marker displayed on a graphical user interface of a terminal of the first member, wherein the marker is shown on an image of a globe representing at least a portion of the Earth at a position associated with a geographic location; selecting the second member based on the selected geographic location, the second member having a member profile associated with the selected geographic location; receiving input from the first member requesting to communicate with the second member; outputting an invitation to a terminal of the second member requesting the second member to communicate with the first member; and receiving input from the second member accepting the invitation from the first member.

In still a further aspect, a computer implemented method for communicating between a first member of a social network and a second member of the social network comprises: randomly showing a first geographic location on an image of a globe representing at least a portion of the Earth, the first geographic location being associated with a member profile of the second member; selecting the second member based on the first geographic location, the second member having a member profile associated with the first geographic location; receiving input from the first member requesting to communicate with the second member; outputting an invitation to a terminal of the second member requesting the second member to communicate with the first member; and receiving input from the second member accepting the invitation from the first member.

### BRIEF DESCRIPTION OF THE DRAWINGS

FIG. 1 illustrates an example social network system in accordance with the present disclosure.

FIG. 2 illustrates a schematic block diagram of the social network control engine of FIG. 1.

FIG. 3 illustrates a schematic block diagram of the user interface engine of FIG. 1.

FIG. 4 illustrates certain features of an example home screen according to one embodiment of a social network according to the present disclosure.

FIG. 5 is a flow chart illustrating an example method for a member of a social network in accordance with the present disclosure to connect with another member of the social network.

FIG. 6 is a block diagram illustrating example physical components of a user computing device usable with a social network system of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

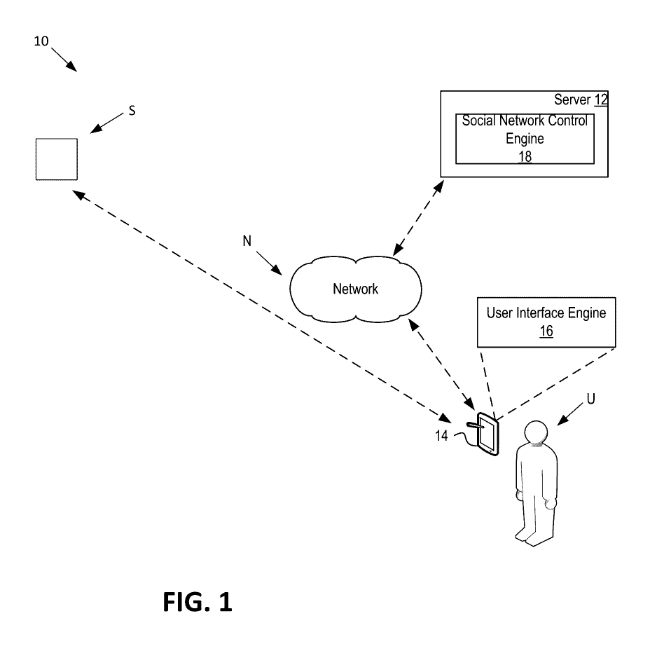

FIG. 1 illustrates an example social network system 10. The system 10 includes a server 12 having a social network control engine 18, and a social network user computing device 14 having a user interface engine 16. Also shown in FIG. 1 are a network N, social network user U, and, optionally, a satellite S in space configured to determine global positioning of one or more users of the social network system 10. The server 12, user computing device 14, network N and satellite S are connected to one or more power sources.

In some embodiments of the social 1 network system 10, the user computing device 14 is connected to the Network N by one or more cables. In some embodiments of the social network system 10, the user computing device is connected to the Network N wirelessly, such as by using Wi-Fi or other wireless technologies.

The user computing device 14 is a computing device. In some embodiments, the user computing device 14 includes a user interface engine 16. In some embodiments, the user computing device 14 is a mobile computing device, such as a tablet computer (such as the iPad® device available from Apple, Inc., or other tablet computers running an operating system like the Microsoft Windows operating system from Microsoft Corporation of Redmond, Wash., or the Android operating system from Google Inc. of Mountain View, Calif.), a smartphone, or other mobile computing device. In some embodiments, the user computing device 14 includes a touch sensitive display for receiving input from a user either by touching (or nearly touching) with a finger or using a stylus. Some embodiments include other input devices and interfaces for receiving input from the user U as well, such as desk top computers or laptop computers.

In some embodiments, the user computing device 14 operates to do one or more of conveying information to the user U and receiving input from the user U. In some embodiments, the user computing device 14 operates to receive inputs from the user U that represent instructions associated with features of the social network system 10. The user computing device 14 then transmits a corresponding instruction to the server 12 via the network N. Upon receiving the instruction, the server then transmits a corresponding instruction to the appropriate one or more user computing devices associated with the social network system 10. Additionally, in some embodiments, the user computing device 14 operates to receive information from the server 12 via the network N. Examples of information received from the server 12 will be described in detail below in connection with the various features of the social network system 10.

In some embodiments, the user computing device 14 transmits/receives communication directly to/from the server 12 such as via a direct Wi-Fi connection. Additionally or alternatively, the user computing device 14 transmits/receives communication to/from the server 12 via one or more intermediary computing devices such as access points, switches, routers, gateways, firewalls, etc.

In some embodiments, the user computing device 14 connects through a wireless network, such as a cellular telephone network. In other embodiments, the user computing device 14 connects to a local area network which may be within a structure, such as a home, office, hotel, coffee shop, or other building. In some embodiments, a connection to the local area network is made wirelessly through a wireless access point connected to the local area network. As already discussed, the user computing device 14 may be a mobile computing device such as a smart phone or a stationary computing device such as desktop computer.

In some embodiments, the social network control engine 18 operates to generate interfaces for presenting information to and receiving input from one or more users U of the social network system 10. In some embodiments, the social network control engine 18 operates to store, process, manage, receive, and/or transmit information associated with one or more users of the social network system 10 and comprises one or more database management applications and one or more web server applications.

Although FIG. 1 shows a single user computing device 14 and a single server 12, other embodiments include additional computing devices, which can be located in one or more different facilities, buildings, or geographic locations. In some embodiments, multiple computing devices communicate with a single server. Additionally, in some embodiments, a single computing device communicates with multiple servers.

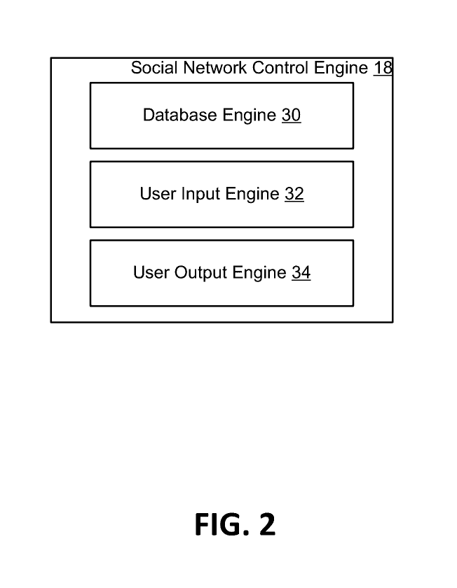

FIG. 2 illustrates a schematic block diagram of the social network control engine 18 of FIG. 1. In some embodiments, the social network control engine 18 includes a database engine 30, a user input engine 32, and a user output engine 34. The database engine 30 operates to communicate with one or more of the user input engine 32, the user output engine 34, and the user interface engine 16 (FIG. 1) and further operates to receive, transmit, store, access, modify, and control data associated with the social network. The user input engine 32 communicates with one or more of the database engine 30, the user output engine 34, and the user interface engine 16 (FIG. 1) and further operates to receive and process data and instructions from users of the social network. The user output engine 34 communicates with the database engine 30, the user input engine 32, and the user interface engine 16 (FIG. 1), and communicates with and transmits processed data and/or instructions and/or requests for user input to one or more computing devices associated with the social network. In some embodiments, the social network control engine 18 includes a separate data processing engine for processing data received, stored, and/or transmitted by the server 12 (FIG. 1), including the database engine 30, the user input engine 32, and/or the user output engine 34. In some embodiments, the social network control engine 18 includes a web interface engine to enable the server 12 (FIG. 1) to communicate with user computing devices 14 (FIG. 1) via the network N (FIG. 1).

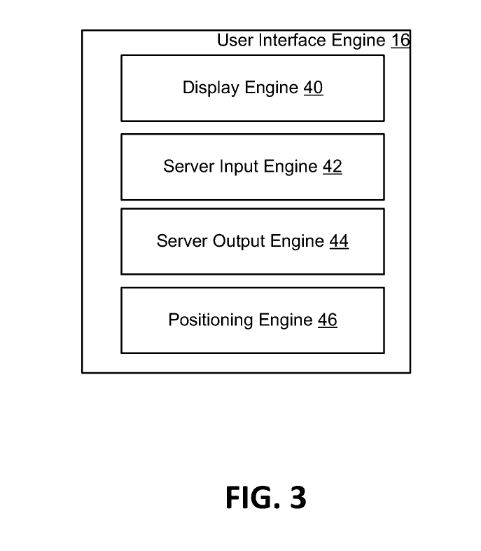

FIG. 3 illustrates a schematic block diagram of the user interface engine 16 of FIG. 1. In some embodiments, the user interface engine 16 includes a display engine 40, a server input engine 42, a server output engine 44, and optionally a positioning engine 46. The display engine 40 operates to display graphics, information, and/or requests for information and/or instructions, on a screen of the user computing device 14 (FIG. 1) in response to data and/or instructions received from the user output engine 34 (FIG. 2), the server output engine 44, and/or the positioning engine 46. The server input engine 42 operates to receive instructions and information from a user U (FIG. 1) via the user computing device 14 (FIG. 1) (e.g., via information/instructions entered via the display engine 40 of the user computing device 14) and/or from the user output engine 34 (FIG. 2), and process and transmit such instructions and information to the server output engine 44. The server output engine 44 operates to receive instructions and/or information from the server input engine 42 (e.g., via information/instructions entered via the display engine 40) and/or the positioning engine 46, and transmit information and/or instructions to the display engine 40 and/or the user input engine 32 (FIG. 2). The optional positioning engine 46 operates to receive positioning data from a positioning device and process and transmit such data to the display engine 40 and/or the server output engine 44. In some embodiments, the social network control engine 18 includes a separate data processing engine for processing data received, stored, and/or transmitted by the server 12 (FIG. 1), including the database engine 30, the user input engine 32, and/or the user output engine 34. In some embodiments, the user interface engine 16 includes a separate data processing engine for processing data received, stored, and/or transmitted by the user computing device 14 (FIG. 1), including the display engine 40, the server input engine 42, and/or the server output engine 44. In some embodiments, the user interface engine 16 includes a web interface engine to enable the user computing device 14 (FIG. 1) to communicate with the server 12 (FIG. 1) via the network N (FIG. 1).

The information, data, and/or instructions receive, processed and/or transmitted by the various engines described above in connection with FIGS. 2 and 3 will be discussed in detail below in connection with specific features and functionality of example web-based social networks in accordance with the present disclosure. Additional, non-exhaustive engines associated with the user interface engine 16 or the social network control engine 18 will be discussed below. It should be understood that each such engine is capable of communicating with one or more of the engines described above. Additional engines not specifically enumerated within this application may optionally also be used to carry out the various features and functionality described herein.

In some embodiments of a web-based social network system 10 (FIG. 1) in accordance with the present disclosure, the social network users U includes a plurality of human members and/or human potential members. Information associated with each member of the social network is stored in one or more locations, such as the server 12. Information associated with members of the social network is selectively accessible to other members of the social network consistent with aspects of the social network system 10 described herein.

Each member of the social network system 10 (FIG. 1) has associated with him/her a profile containing information about that member. Profile information about each member user is introduced to the social network system 10 (FIG. 1) via the user interface engine 16 (FIG. 1) of the user computing device 14 (FIG. 1). Non-limiting examples of the types of information in member profiles include the member's age, gender, occupation, school, location, interests (e.g., travel interests, food/drink interests), relationship status, social interests, languages spoken, languages proficient in, one or more images (such as a picture of the member), travel history, travel plans, other member connections, and so forth.

### Becoming a New Member of the Network

To become a member of an example web-based social network in accordance with the present disclosure, a non-member opens an account on the social network. In some examples the account is security enabled (e.g., password protected). To open an account, the non-member creates a profile by providing certain information about the non-member, such as the non-member's age and gender. Although in some examples each account is associated with the member's actual name, the member profile can additionally or alternatively include an alias for privacy purposes.

When creating an account the non-member provides his/her primary geographic location (e.g. a city, address, zip code, global coordinates etc.). In alternative embodiments the social network automatically assigns a primary geographic location to the non-member using a positioning device (e.g., a satellite global positioning device S (FIG. 1) in communication the non-member user's computing device 14 (FIG. 1) or terminal (personal computer, smart phone, tablet, laptop, etc.)) to detect the location of the non-member when he/she is opening an account. The geographic location input is then processed, e.g, by a data processing engine associated with the server 12, which automatically associates the input with a hub location. In some examples, hub locations are predetermined in the network. Hub locations can be predetermined through any suitable criteria, such as geography, population, and so forth. For example, at least one hub location can be associated with each country in the world and/or with each state in the United States, and/or with each capital city of each country, state, province, and/or principality. In addition or alternatively, a hub location is predetermined for each city in the world having a predetermined minimum population (e.g., 100,000, 500,000, and so forth). In addition or alternatively, determining hub locations can be conditional on geographic proximity to other hub locations. For example, if a potential hub location would otherwise meet the criteria of a hub location but is within a predetermined maximum distance (e.g., 100 miles) of another hub location that has a greater population, the social network does not treat the potential hub location as a hub location. In some examples, the social network control engine 18 (FIG. 2) includes a hub location determination engine that operates to associate members of the social network with a particular hub location by processing location data received from the database engine 30 (FIG. 2), the server output engine 44 (FIG. 3), and/or the positioning engine 46 (FIG. 3), and/or components thereof.

In some examples, the geographic location input by the non-member is associated with the hub location that is nearest in distance. In other examples, the geographic location is associated with the hub location that is within the same country or state as the geographic location. In still further examples, if the difference between the distance from the input geographic location and each of two or more hub locations is less than (or less than or equal to) a predetermined quantity, the non-member is prompted to select one of the two or more hub locations as the hub location that will be associated with his/her member profile. For example, if the geographic location input is X, and X is within a predetermined distance of a hub location Y and a hub location Z, then the non-member is prompted to select either Y or Z as the hub location to be associated with his/her profile.

Following submission of at least the minimum amount of information required to open an account in the social network, the account is opened and the non-member becomes a member of the social network.

Once an account has been opened, information about the member's profile can be added and/or modified. For example, after logging into an account, the member can select one or more member settings (e.g., from one or more drop down menus of settings) to modify. Non-limiting examples of settings include profile settings, display settings, login settings, privacy settings, and so forth). In some examples, the member can modify his primary geographic location (e.g., if he/she has moved or is travelling), prompting the social network (e.g., via data processing performed by a hub location determination engine), to reassign a new hub location to the member's profile.

Connecting to and Interacting with Other Members of the Network

To connect with other members of an example web-based social network, a first member (“Member A”) logs into an account associated with Member A, e.g., by inputting login credentials such as a login name and password. After logging into his/her account, Member A is shown a home screen. Instructions for logging in and the home screen itself are displayed via, e.g., the display engine 40 (FIG. 3). In some embodiments, the home screen includes an image representing at least portion of the Earth (e.g., a map). In some examples, the home screen includes an image representing the entire Earth. In still further examples, the home screen includes an image of at least a portion of the Earth, the image being a globe. The image of at least a portion of the Earth optionally illustrates land masses, water masses, country demarcations, state demarcations, and/or province demarcations. Optionally, other geographical, topographical, and/or political features are also illustrated.

The home screen can be dynamic or static. For example, the image representing at least a portion of the Earth can regenerate to show a different portion of the Earth through one or more user inputs (e.g., via the server input engine 42 (FIG. 2)). For example, in the case of a globe displayed on the home screen, upon receiving the user input to display a different part of the Earth, the globe spins (e.g., about the Earth's axis) for a predetermined (or alternatively random), length of time, and at predetermined (or alternatively random) rate of rotation, and then stops spinning and displays a randomly selected different part of the Earth. In alternative examples, the globe does not spin, and instead automatically regenerates a random part of the Earth upon receiving the user input to display a different part of the Earth.

In addition, the image of at least a portion of the Earth illustrates one or more markers at one or more specific locations on the land masses. In some examples only one type of marker is illustrated. In other examples, a plurality of marker types are illustrated, each type representing a unique type of information.

In a particular embodiment, two marker types are employed: a first marker type appears at each visible hub location in which Member A has no connections to other members of the social network; and a second marker type appears at each visible hub location in which Member A has connections with at least one other member of the social network. In alternative examples, the first marker type appears at each visible hub location associated with a member with whom Member A is not connected, regardless of whether Member A is connected with other members at that hub location. In other words, the first marker type appears at each visible hub location in which Member A has at least one non-connection with another member of the social network. Thus, in some examples, multiple marker types can appear at the same hub location. The particular types selected for the markers can be any of a large variety, and in some examples are customizable by the social network members (e.g., as a modifiable account setting). For example, the first type of marker can be a dot, circle, triangle, star, or so forth; and the second marker can be a pin-shaped object, flag, or so forth. In alternative embodiments, a third marker type is employed, which appears at each visible hub location in which Member A has connections with at least one other member of the social network whom Member A has designated as a subset of his/her connections, e.g., a “friend,” or “buddy,” or “favorite,” or “preferred” connection. Subset connections will be discussed in more detail below. In some examples the third type of marker is aesthetically configured entirely differently from the first and second type of markers. In other examples, the third type of marker is geometrically similar to the second type of marker (e.g., both are pin-shaped objects) but embodies a different color or symbol than the second type of marker. It should be appreciated that further marker types (e.g. a fourth, fifth, etc.) could also be employed in accordance with the principles disclosed herein (e.g., in order to indicate additional species of subset connections, preferred hub locations, and so forth).

In some embodiments, another marker having a distinct aesthetic appearance is displayed on the user's home screen at one or more hub locations determined to be a featured (e.g., promoted) hub location. Featured hub locations for each user can be selected based on the user's own hub location. For example, if Member A is associated with hub X, then hub X never appears on Member A's home screen as a featured hub. Featured hub locations can be employed, e.g., to encourage users to make connections or communicate with existing connections located at the featured hub location. In some examples, the featured hub location automatically changes on a regular (or irregular basis), e.g., daily, weekly, monthly. The featured hub location can be alternatively selected by an administrator of the social network or based on the execution of computer readable instructions read by a processing device within the social network. In some examples, a single featured hub location marker appears as a star at the featured hub location on each user's home screen on a given day. In other examples, more than one featured hub locations are displayed on each user's home screen on a given day. In some examples, one or more web-based advertisements (discussed in more detail below) specific to, or associated with the one or more featured hub locations on a given day, are displayed on the user's home screen and/or upon selection by the user of the featured hub location marker.

In some embodiments, the home screen includes a toggling option (e.g., selectable by operating a toggling icon that displays a drop down menu of options), which allows Member A to select which type of marker displays on the home screen. For example, in some embodiments Member A can operate the toggling feature such that only markers indicating hub locations in which member A has connections with at least one other member of the social network are displayed; alternatively Member A can operate the toggling feature such that only markers indicating hub locations in which Member A has no connections with other members of the social network are displayed; alternatively, Member A can operate the toggling feature such that only markers indicating hub locations in which Member A has at least one non-connection with other members of the network are displayed; and/or in some embodiments Member A can operate the toggling feature such that only markers indicating hub locations in which Member A has least one subset connection (e.g., a preferred connection) are displayed. If Member A has more than one type of connection at a given hub location (e.g., at least two of: a non-connection with another member, a regular connection with another member, and a subset connection with another member), in some embodiments the toggling feature ensures that only the selected marker type is displayed at the given hub location.

In a particular embodiment, two different types of marker are employed, the first type of marker being a dot or small circle and the second type of marker being a pin. When Member A selects a pin-type marker associated with a hub location X on Member A's home screen, in some examples an existing connections engine in the social network control engine 18 (FIG. 2) causes the user's display to populate indicating each network member associated with X that Member A is already connected with. For example, for each member associated with X with whom a connection has previously been established with Member A, the display shows one or more types of information from that member's profile, such as a photograph of the member, name and/or alias, hub location (i.e., X), a flag associated with the hub location (e.g., a national or state flag), and so forth. In some examples, selecting the marker of the second type also prompts Member A to optionally connect to one or more other members of the network associated with X. In some examples, when Member A indicates that he/she would like to connect with one or more other members associated with X, a display appears that shows (entirely on one screen or optionally on multiple screens via, e.g., a scrolling or swiping feature) information (e.g., profile information) about every single social network member associated with X with whom Member A is not connected. In other examples, when Member A indicates that he/she would like to connect with one or more other members associated with X, in some examples a non-existing connections engine in the social network control engine 18 (FIG. 1) causes a display to appear to the user that shows information about social network members associated with X who meet predetermined criteria (e.g., age, gender, language, relationship status) previously set by Member A (e.g., in Member A's settings and/or profile) and with whom Member A is not connected. In still further examples, when Member A indicates that he/she would like to connect with one or more other members associated with X, Member A is prompted to input one or more criteria that define the members at X with whom Member A would like to connect. Non-exhaustive examples of such criteria include age (or age range), gender, languages spoken and/or proficient in, relationship status, interests, and so forth. Member A inputs the one or more criteria and a display appears that shows (entirely on one screen or optionally on multiple screens) information about every single social network member associated with X that meets the input criteria and with whom Member A is not connected. In addition or alternatively, Member A is optionally prompted to indicate that he/she desires to be shown a randomly generated social network member associated with X who meets one or more criteria selected by Member A. If Member A indicates that he/she desires to be shown a randomly generated network member associated with X, a random connection engine in the social network control engine 18 (FIG. 1) randomly selects a member associated with X who satisfies the one or more criteria, and with whom Member A is not connected, and a display appears that shows information about that randomly selected member.

When Member A is shown information about one or more social network members associated with X with whom Member A is not connected, Member A is prompted to optionally connect or “send an invitation to chat” with that member. In some examples, Member A is also prompted optionally to remove from the display one or more members with whom he/she does not wish to connect. If Member A inputs a request to connect with another member associated with X (“Member B”), an invitation is sent to Member B's account. When Member B logs into his/her account, Member B is notified that Member A wishes to connect. Member B is shown information about Member A, such as Member A's age, name and/or or alias, hub location (for purposes of this example, Member A is associated with hub Y), interests, photograph, and/or languages spoken. Member B is then prompted to optionally accept or decline the invitation from Member A. If Member B accepts the invitation from member A, Member A and Member B become enabled to chat with each other through electronic messaging (text, voice, videoconferencing, or so forth) when both Member A and Member B are logged into their respective network accounts. In some examples, messages can also left for each member by the other which can be retrieved when the member logs in to his/her account. If prior to accepting Member A's invitation Member B had no network connections associated with hub Y, then in some examples, upon accepting Member A's invitation, a marker of the second type (e.g., a pin), is automatically positioned at hub Y on Member B's home screen. The marker of the second type covers over or replaces (or, in some examples, displays simultaneously with) the marker of the first type (e.g. a dot) that was previously positioned at hub Y on Member B's home screen. The marker of the second type can be a dynamic or static graphic feature. In some examples, the marker of the second type is a pin that “drops” down onto the hub Y position after Member B accepts Member A's invitation.

In some examples, connected members have access to more types of information about the members with whom they are connected than with members with whom they are not connected.

After Member A and Member B are connected, either may disconnect from the other at any time by logging into their own respective account, selecting the other member, and indicating, via a prompt, that they no longer wish to be connected with the other member.

When Member A selects a first-type marker (e.g., a dot) at a hub location Z, in some examples Member A is prompted to optionally connect to one or more other members of the network associated with Z. In some examples, when Member A indicates that he/she would like to connect with one or more other members associated with Z, a display appears that shows (entirely on one screen or optionally on multiple screens via, e.g., a scrolling or swiping feature) information (e.g., profile information) about every single network member associated with X with whom Member A is not connected. In other examples, when Member A indicates that he/she would like to connect with one or more other members associated with Z, Member A is prompted to input one or more criteria that define the members at Z with whom Member A would like to connect. Non-exhaustive examples of such criteria include age (or age range), gender, languages spoken and/or proficient in, relationship status, interests, and so forth. Member A inputs the one or more criteria and a display appears that shows (entirely on one screen or optionally on multiple screens) information about every single social network member associated with Z that meets the input criteria and with whom Member A is not connected. In still further examples, when Member A indicates that he/she would like to connect with one or more other members associated with Z, a display appears that shows information about social network members associated with Z who meet predetermined criteria (e.g., age, gender, language, relationship status) previously set by Member A (e.g., in Member A's settings and/or profile) and with whom Member A is not connected. In addition or alternatively, Member A is optionally prompted to indicate that he/she desires to be shown a randomly generated network member associated with Z who meets one or more criteria selected by Member A. If Member A indicates that he/she desires to be shown a randomly generated network member associated with Z, a data processing engine associated with the server 12 randomly selects a member associated with Z who satisfies the selected criteria and with whom Member A is not connected and a display appears that shows information about that randomly selected member.

When Member A is shown information about one or more network members associated with Z, Member A is prompted to optionally connect or “send an invitation to chat” with that member. If Member A inputs a request to connect with another member associated with Z (“Member C”), an invitation is sent to Member C's account. When Member C logs into his/her account, Member C is notified that Member A wishes to connect. Member C is shown information about Member A, such as Member A's age, name and/or alias, hub location (for purposes of this example, Member A is associated with hub Y), interests, photograph, and/or languages spoken. Member C is then prompted to optionally accept or decline the invitation from Member A. If Member C accepts the invitation from Member A, Member A and Member C become enabled to chat with each other through electronic messaging (text, voice, or so forth) when both Member A and Member Care logged into their respective network accounts. In some examples, messages/communications can also be left for each member by the other which can be retrieved when the member logs into his/her account. If, prior to accepting Member A's invitation, Member C had no network connections associated with hub Y, then in some examples, upon accepting Member A's invitation, a marker of the second type (e.g., a pin), is automatically positioned at hub Y on Member C's home screen. The marker of the second type covers over or replaces (or, in some examples, displays simultaneously with) the marker of the first type (e.g., a dot) that was previously positioned at hub Y on Member C's home screen. The marker of the second type can be a dynamic or static graphic feature. In some examples, the marker of the second type is a pin that “drops” down onto hub Y position after Member C accepts Member A's invitation. Upon Member C's accepting of Member A's invitation to chat, a marker of the second type covers over or replaces (or, in some examples, displays simultaneously with) the marker of the first type (e.g., a dot) that was previously positioned at hub Z on Member A's home screen. The marker of the second type remains at hub Z on Member A's home screen as long as Member A is connected with at least one member of the social network associated with hub Z. The marker of the second type can be a dynamic or static graphic feature. In some examples, the marker of the second type is a pin that “drops” down onto the hub Z position after Member B accepts Member A's invitation. If at a point in time Member A loses all connections at hub Z (e.g., Member A's hub Z connections disconnect with Member A or vice versa, and/or Member A's hub Z connections become associated with a hub location other than Z), hub Z reverts to displaying the marker of the first type (e.g., a dot) only, indicating that Member A has no social network connections at hub Z. In some examples, should one of Member A's member connections become associated with a different hub location at which Member A previously had no connection, the hub location to which the member connection transfers will automatically display a marker type indicating that a connection there now exists.

In an alternative embodiment, three different types of marker are employed, the first type of marker being a dot or small circle, the second type of marker being a pin having a first indicia (e.g., color, symbol), and the third type of marker being a pin having a second indicia different from the first indicia. In this embodiment, the functionality associated with selecting the first type of marker and the second type of marker is consistent with the disclosure above. When Member A selects a third marker type associated with a hub location, a subset connection engine in the social network control engine 18 (FIG. 2) causes Member A to be shown information about one or more of his/her connections associated with that hub whom member A has designated as a subset connection (e.g., a preferred connection). In some examples, designating a connection as a subset connection can be performed at any time after a regular connection has been made (i.e., at any time after an invitation to connect has been sent and accepted). In some examples, when information about a member connection of Member A is displayed to Member A, Member A is optionally prompted to designate that member connection as a subset connection. Conversely, in some examples, when information about a subset connection of Member A is displayed to Member A, Member A is optionally prompted to de-designate the subset connection and revert the subset connection to ordinary connection status. In some examples, when members of the network have mutually designated each other as the same type of subset connection, additional information about the other member and/or additional forms of communication between the two members become accessible that are not accessible otherwise. In some examples, if Member A designates a member connection as a subset connection at a given hub location at which Member A previously had no subset connections, that hub location automatically displays the third type of marker on Member A's home screen. Display of the third marker type at a given hub location can be in conjunction with, or exclusive of, one or more other marker types at that hub location, as described above. Conversely, if Member A de-designates a subset member associated with a given hub location at which Member A has no other subset connections, the third marker type stops displaying at that hub location on Member A's home screen. Similarly, in some examples, should one of Member A's subset connections become associated with a different hub location at which Member A previously had no subset connection, the hub location to which the subset connection transfers will automatically display a marker type indicating that a subset connection there now exists.

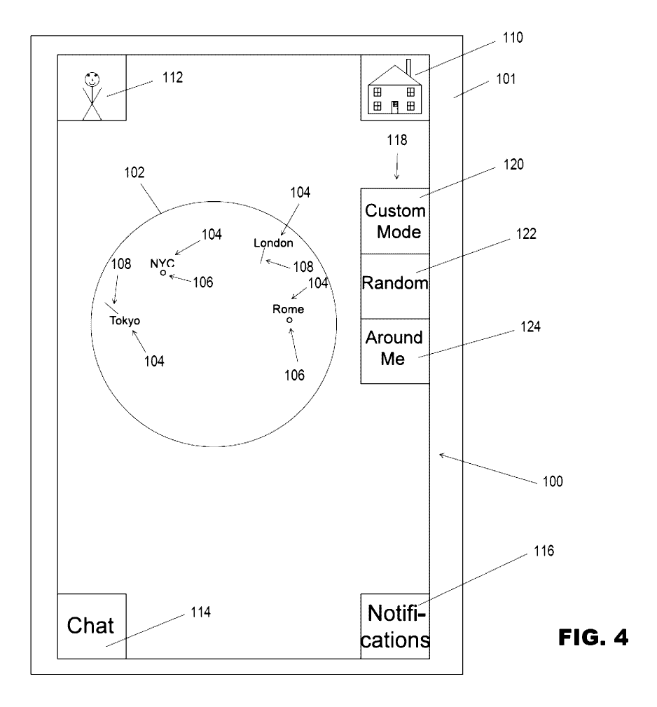

FIG. 4 illustrates certain features of an example home screen 100 on a graphical user interface (“GUI”) 101 of computing device/terminal 14 (FIG. 1) according to one embodiment of a social network in accordance with the present disclosure. Although one possible configuration of a home screen is shown, it should be understood that the relative positioning of the various features of the home screen 100 may be varied and/or customizable. In addition, not all the features shown are required, and additional features not shown in FIG. 1 can be added to the home screen 100 in accordance with the present disclosure.

To access the example home screen 100, a member (“Member D”) of a social network in accordance with the present disclosure logs into his/her network account. Account logins can be performed through a website dedicated to a social network of the present disclosure, through a software application downloaded to a device (e.g., the computing device 14 (FIG. 1)) with internet access, and/or alternatively, by logging into an existing web-based social network platform that has been modified to provide the features of the present disclosure. In one example, to access the home screen Member D logs into an account on an existing social network and selects an icon displayed as part of that account that opens one or more of the features of the present disclosure, including, e.g., a home screen of the present disclosure.

The example home screen 100 includes an image of a globe 102, including one or more hub locations 104. Each of the hub locations 104 is demarcated with either a marker of the first type 106 or a marker of the second type 108. The marker of the first type 106 indicates hub locations in which Member D has no network connections. The marker of the second type 108 indicates hub locations in which Member D has one or more network connections. Optionally, the home screen 100 includes an interactive home button 110 (e.g., a button icon) indicating that Member D is viewing his/her home screen 100. Optionally, the interactive home button 110 appears on every screen and contains a link back to the home screen 100 when selected.

Optionally, the home screen 100 includes a member image 112 that is associated with Member D's account profile. In some examples, the member image 112 is interactive and linked to Member D's profile and profile settings. In alternative examples, Member D's profile and/or profile settings are accessible in other ways from the home screen 100. In some examples Member D selects the member image 112 icon to display and/or modify the information contained in his/her profile. The profile includes information such as, e.g., Member D's age, gender, and primary language, Member D's age and gender preferences for connecting with other network members, a biography of Member D (optionally limited to a maximum number of characters or words), and so forth.

In some examples, upon opening the home screen 100, the globe 102 defaults to a display that includes Member D's associated hub location. Additionally or alternatively, when the interactive home button 110 is selected the globe 102 automatically spins to a position in which Member D's associated hub location is central or approximately central. In addition or alternatively, the interactive home button 110 itself indicates Member D's associated hub location. The globe 102 is enabled for customizable view settings, such as panning, zooming, spinning, and the like, through user inputs. The markers of the first type 106 and the markers of the second type 108 are selectable by Member D in the manner described above.

In this example, the home screen 100 also includes an interactive chat icon 114 (e.g., a button icon). Selecting the interactive chat icon 114 opens a chat screen on the GUI 101 for chatting with one or more members of the social network. In some examples, selecting the interactive chat icon 114 displays one or more members of the social network with whom Member D is connected and enables chatting with same. In some examples, selecting the interactive chat icon 114 displays one or more members of the social network with whom Member D is connected and who are presently logged into their respective accounts, and enables chatting with same. In the example shown in FIG. 1, the home screen 100 also includes an interactive notifications icon 116 (e.g., a button icon). Selecting the interactive notifications icon 116 opens a window on the GUI 101 displaying pending chat requests that Member D has sent to other members of the social network with whom Member D is not connected, as well as pending invitations to Member D to chat from members of the network with whom Member D is not connected. In some examples, a notification is sent to the appropriate member of the social network whenever a pending chat request or invitation has been accepted or declined.

The example home screen 100 also includes a plurality of user selectable modes 118 for operating the social network. In one example the user selectable modes 118 include a “custom” mode 120, a “random” mode 122, and an “around me” mode 124, each of which is selectable by the user by selecting the appropriate icon on the home screen 100.

In some examples, selection of the custom mode 120 (e.g., by selecting an icon button) prompts the user for a manual input of the name of a location (e.g., zip code, city, region, country, continent, geographic coordinates, etc.) where the user would like to connect with one or more other members of the network. For example, Member D may be interested in Italy and/or may be travelling to Rome, Italy and wish to connect with one or more members of the network associated with the hub location Rome, Italy. Upon Member D's inputting of the location of interest, e.g., “Rome,” in some examples the display engine in the social network control engine 18 (FIG. 2) causes the globe 102 to spin and center itself about the hub location (Rome, in this example) associated with the inputted location of interest. In some examples, the globe 102 also zooms in on Rome. In some examples, this step is alternatively accomplished by selecting (e.g., clicking on) the globe 102 at a hub location (e.g., Rome). In some examples, upon inputting the location of interest, Member D is automatically presented (e.g., via non-existing connections engine) with information about one or more members in Rome with whom Member D is not connected. In some examples, the displayed members have been filtered based on criteria (e.g., gender, age range) set by Member D for members that Member D is interested in connecting with. The information displayed may include but is not limited to one or more of the following: profile pictures of members associated with Rome, biographies, gender, age, location, national flag, and so forth. Member D has the option to send or decline to send an invitation to each member he/she is presented with. In other examples, once the globe 102 adjusts to the view of Rome, Rome is shown demarcated with either a marker of the first type 106 or a marker of the second type 108 as described above. Member D then selects the marker of the first type 106 or the marker of the second type 108 appearing at Rome in order to see information about the one or more members in Rome with whom Member D is not connected. Member D then has the option to send or decline to send an invitation to connect to each member he/she is presented with. If Rome is initially associated with a marker of the first type 106, and Member D sends an invitation to connect (e.g., via a connection request engine associated with the social network control engine 18 (FIG. 2)) with a member associated with Rome who accepts the invitation, the marker of the first type 106 at Rome is replaced with a marker of the second type 108 (e.g., via a connection creation engine associated with the social network control engine 18 (FIG. 2)), indicating that Member D has at least one member connection in Rome. After entering the custom mode 120, the user may optionally select the interactive home button 110 to return to the home screen 100.

In some examples, selection of the random mode 122 (e.g., by selecting an icon button) causes a random connection engine associated with the social network control engine 18 (FIG. 1) to cause the globe 102 to spin and stop spinning on a random hub location (e.g., London, UK). In some examples, this step is alternatively accomplished by selecting (e.g., clicking on) the globe 102 outside of all hub locations (e.g., by clicking on an ocean or other body of water), causing the globe 102 to spin and randomly stop on a hub location (e.g., London). In some examples, the globe 102 also zooms in on London. In some examples, the random mode 122 is configured such that it does not stop on Member D's associated hub location. Member D can then select London or alternatively select the random mode 122 again for a further random spin of the globe 102 and presentation of a random hub location. The random mode 122 can be selected repeatedly in this manner until a desirable hub location appears. In some examples, London is shown demarcated with either the marker of the first type 106 or the marker of the second type 108, as described above. If Member D selects the marker associated with London, information about one or more members in London with whom Member D is not connected is displayed. In some examples, the displayed members have been filtered based on criteria (e.g., gender, age range) set by Member D for members that Member D is interested in connecting with. Member D then has the option to send or decline to send an invitation to connect to each member he/she is presented with. If London is initially associated with a marker of the first type 106, and Member D sends an invitation to connect with a member associated with London who accepts the invitation, the marker of the first type 106 at London is replaced with a marker of the second type 108, indicating that Member D has at least one member connection in London. After entering the random mode 122, the user may optionally select the interactive home button 110 to return to the home screen 100.

In some examples, selection of the optional “around me” mode 124 causes a vicinity connection engine associated with the social network control engine 18 to cause the globe 102 to spin and stop spinning at (and, in some examples zoom in on) Member D's own associated hub location (e.g., New York City (“NYC”)). This is accomplished, e.g., by accessing and processing information stored on the server 12 regarding Member D's hub location. Member D is then presented with information (e.g., profile picture, biography gender, age, etc.) about one or more members associated with NYC that Member D is not connected with and to whom Member D may optionally send or decline to send an invitation to connect with one or more of such members. In some examples, information from only those members having an address within a predetermined distance (e.g., 30 miles) of Member D's current location (e.g., current address, current global coordinates, etc.) will be shown to Member D. In some examples, the displayed members have been filtered based on criteria (e.g., gender, age range) set by Member D (e.g. in member D's account profile and/or account settings) for members that Member D is interested in connecting with. After selecting the “around me” mode 124, the user may optionally select the interactive home button 110 to return to the home screen 100.

For communications (e.g., invitations to chat, chats, and so forth) between members of a social network in accordance with the present disclosure whose respective primary languages as indicated in their respective profiles are different from each other, in some examples the network is configured to translate via a translation engine associated with one or both of the social network control engine 18 (FIG. 2) and the user interface engine 16 (FIG. 3), automatically or upon user input, communications from a transmitting member to a receiving member into the primary language of the receiving member.

In some examples, selection of a hub location on the globe 102 causes a news feed engine associated with the social network control engine (FIG. 2) to present the user with additional options to view and/or contribute to a “news feed” specifically associated with the hub location selected. In some examples, this “news feed” contains information and posts from network members specific to the hub location. Contributions to the “news feed” could include, for example, information about the member's travel plans to that hub location and/or criteria for members he/she would like to connect with at that hub location.

In addition, in some examples the social network of the present disclosure is configured with location-based advertising. In some examples, an advertisement engine associated with the social network control engine 18 (FIG. 2) and/or the user interface engine 16 (FIG. 3), and which communicates via a network to one or more devices of one or more advertisers, causes advertisements specific to the member's own hub location to appear on that member's screen when logged into his/her account. In addition or alternatively, advertisements associated with hub locations that a member has selected for connecting to or communicating with other members can be specific to those hub locations that have been selected. For example, a member associated with the hub location of New York City is shown advertisements specific to New York City when logged on to his account on the social network, and/or is shown advertisements specific to Paris, France when selecting the hub location of Paris to connect with other members or communicate with other members associated with that hub.

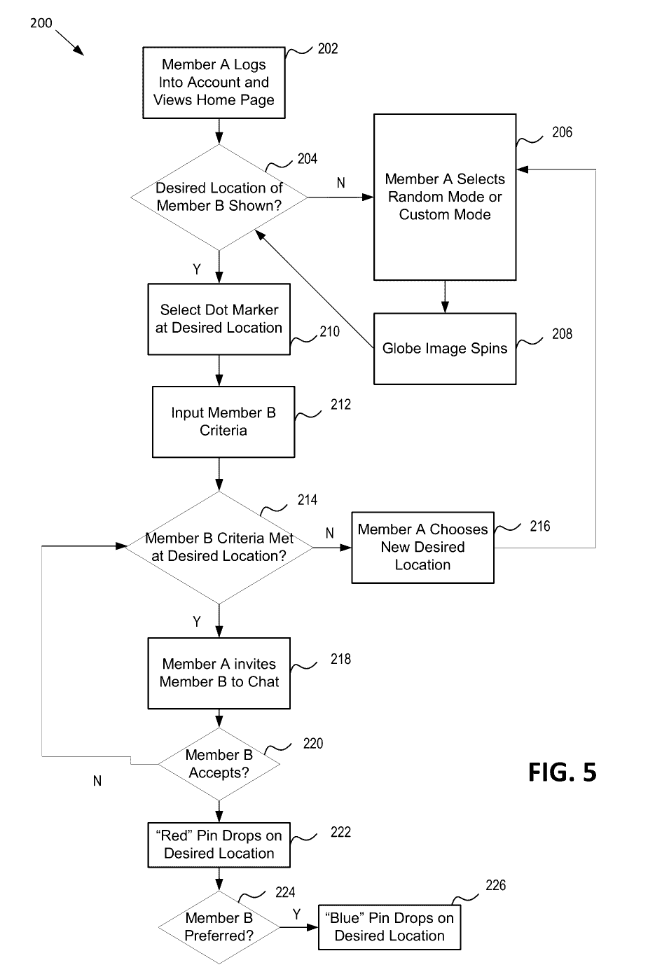

FIG. 5 is a flow chart illustrating certain example steps of an example method 200 for a Member A of a social network in accordance with the present disclosure to connect with a Member B of the social network. In this example, it is assumed that Member A has no connections at the desired hub location of Member B. In an operation 202, Member A logs into his/her social network member account via a computing device/terminal that is connected to the social network server via the internet, and Member A's home screen appears, including an image of a globe. In an operation 204, Member A determines if the desired hub location for the potential new connection with Member B is shown on the home screen. If it is not, in an operation 206 Member A selects Random Mode or Custom Mode as described above, causing the globe image to spin in an operation 208, and then Member A then determines again if the desired hub location for Member is shown by going back to operation 204. Once the globe shows the desired location for Member B, in an operation 210 member A selects the dot marker positioned at the desired location. In an operation 212, Member B inputs one or more criteria desired for Member B. In an operation 214, information about zero or more members associated with the desired location that meet the input criteria are displayed to member A. In an operation 216, if zero members associated with the desired location meet the input criteria exist, Member A chooses a different desired location (alternatively, Member A is prompted to input different search criteria for Member B at the already selected desired location), which brings Member A back to operation 206. If one or more members at the desired location meet the input criteria, in an operation 218, Member A invites at least one such member (Member B) associated with the desired location to chat. In an operation 220, if Member B does not accept Member A's invitation, Member A is brought back to operation 214; if Member B does accept Member A's invitation, in an operation 222 a pin of a first color (for example) drops on the desired location of Member A's home screen indicating that Member A now has a connection at the desired location. In an optional operation 224, Member A decides whether to designate Member B as a preferred connection. In an operation 226, Member A designates Member B as a preferred connection, and a pin of a second color (for example) drops (in some examples the pin replaces the pin of the first color) at the desired location on Member A's home screen indicating that Member A now has a preferred connection at the desired location.

### Implementation

As described above, access to a web-based social network in accordance with the present disclosure may be optionally implemented via a downloaded software application, a website dedicated to the social network, and/or through an existing web-based social network. In some examples, a social network in accordance with the present disclosure includes one or more host servers having a computer readable storage device that stores computer readable instructions, and a plurality of terminals (e.g., a personal computer, laptop, tablet, smart phone, or the like) that are connected (actually or virtually) to the host server such that the terminals on the one hand and the host server on the other hand can transmit and receive data from one another. In some examples, the host server(s) store(s) information (e.g., profile information, settings information) regarding members of the network and is/are configured to transmit information regarding member profiles to the terminals. Each of the terminals (i.e., user computing devices) provides access to the social network by its members or prospective members. Each terminal includes one or more data input mechanisms (e.g. a mouse, keyboard, touch screen, and so forth) for sending instructions to the host server and/or to a data processing device (e.g., a microprocessor) specifically associated with the terminal itself. Such instructions enable the running of at least some of the features and functionality of the social network described above (e.g., one of the user selectable modes 118 (FIG. 4)) via one or more of the engines provided above. Each terminal also includes a dynamic and interactive graphical user interface that enables the user of the terminal to interact with the social network by inputting commands through one or more data input mechanisms. Each processing device is configured to execute instructions input by the user of the terminal via one or more of the data input mechanisms. The processing device is also involved in controlling output to the GUI of the terminal.

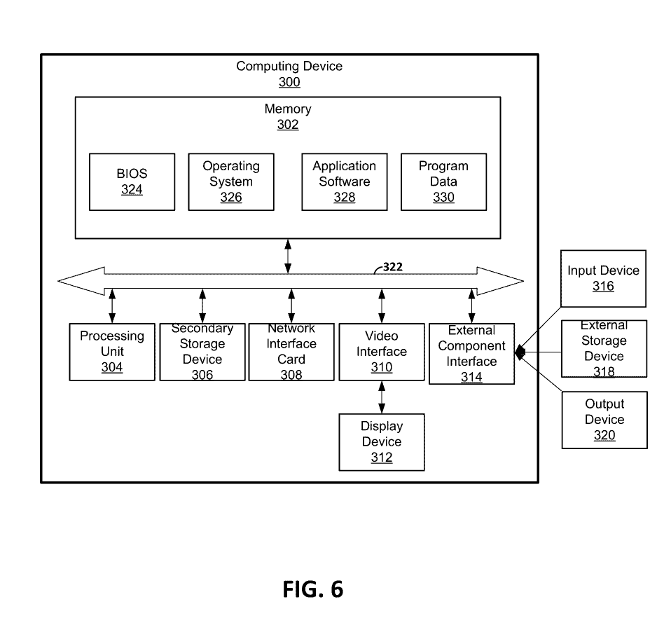

FIG. 6 is a block diagram illustrating example physical components of a user computing device 300. In some embodiments, the computing device 300 is implemented using multiple computing devices. It should be appreciated that in other embodiments, the computing device 300 is implemented using physical components other than those illustrated in the example of FIG. 6. In some embodiments, the computing device 300 is used to implement one or more of the server 12, the user computing device 14, or the network N (FIG. 1).

In the example of FIG. 6, the computing device 300 comprises a memory 302, a processing unit 304, a secondary storage device 306, a network interface card 308, a video interface 310, a display device 312, an external component interface 314, an input device 316, an external storage device 318, an output device 320, and a communications medium 322. In other embodiments, computing devices are implemented using more or fewer hardware components. For instance, in another example embodiment, a computing device does not include a video interface, a display device, an external storage device, or an input device.

The memory 302 includes one or more computer-readable data storage media capable of storing data or instructions or both. In different embodiments, the memory 302 is implemented in different ways. For instance, in various embodiments, the memory 302 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data. In some embodiments, the memory 302 includes non-transitory media.

The processing unit 304 includes one or more physical integrated circuits that selectively execute software instructions. In various embodiments, the processing unit 304 is implemented in various ways. For instance, in one example embodiment, the processing unit 304 is implemented as one or more processing cores. For instance, the processing unit 304 may be implemented as one or more Intel Core 2 microprocessors. In another example embodiment, the processing unit 304 is implemented as one or more separate microprocessors. In yet another example embodiment, the processing unit 304 is implemented as an ASIC that provides specific functionality. In yet another example embodiment, the processing unit 304 provides specific functionality by using an ASIC and by executing software instructions.

In different embodiments, the processing unit 304 executes software instructions in different instruction sets. For instance, in various embodiments, the processing unit 304 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 306 includes one or more computer-readable data storage media. The secondary storage device 306 stores data and software instructions not directly accessible by the processing unit 304. In other words, the processing unit 304 performs an I/O operation to retrieve data and/or software instructions from the secondary storage device 306. In various embodiments, the secondary storage device 306 is implemented by various types of computer-readable data storage media. For instance, the secondary storage device 306 may be implemented by one or more magnetic disks, magnetic tape drives, CD-ROM discs, DVD-ROM discs, Blu-Ray discs, solid state memory devices, Bernoulli cartridges, and/or other types of computer-readable data storage media. In some embodiments, the secondary storage device 306 includes non-transitory media.

The network interface card 308 enables the computing device 300 to send data to and receive data from a computer communication network. In different embodiments, the network interface card 308 is implemented in different ways. For example, in various embodiments, the network interface card 308 is implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display device 312. In different embodiments, the video interface 310 is implemented in different ways. For instance, in one example embodiment, the video interface 310 is integrated into a motherboard of the computing device 300. In another example embodiment, the video interface 310 is a video expansion card. Example types of video expansion cards include Radeon graphics cards manufactured by ATI Technologies, Inc. of Markham, Ontario, Geforce graphics cards manufactured by Nvidia Corporation of Santa Clara, Calif., and other types of graphics cards.

In various embodiments, the display device 312 is implemented as various types of display devices. Example types of display devices include, but are not limited to, cathode-ray tube displays, LCD display panels, plasma screen display panels, touch-sensitive display panels, LED screens, projectors, and other types of display devices. In some embodiments, the display device 312 is integral with the computing device 300. However, in other embodiments, the display device 312 is a separate component from the computing device 300. In various embodiments, the video interface 310 communicates with the display device 312 in various ways. For instance, in various embodiments, the video interface 310 communicates with the display device 312 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 314 enables the computing device 180 to communicate with external devices. In various embodiments, the external component interface 314 is implemented in different ways. For instance, in one example embodiment, the external component interface 314 is a USB interface. In other example embodiments, the external component interface 314 is a FireWire interface, a serial port interface, a parallel port interface, a PS/2 interface, and/or another type of interface that enables the computing device 300 to communicate with external components.

In different embodiments, the external component interface 314 enables the computing device 300 to communicate with different external components including but not limited to a user input device, an external storage device, speakers, phone charging jacks, modems, media player docks, other computing devices, scanners, digital cameras, a fingerprint reader, and other devices that can be connected to the computing device.

The input device 316 is a component that provides user input to the computing device 300. Different implementations of the computing device 300 interface with different types of input devices. Example types of input devices include, but are not limited to, keyboards, mice, trackballs, stylus input devices, key pads, microphones, joysticks, touch-sensitive display screens, and other types of devices that provide user input to the computing device 300. In some embodiments, the input device 316 is external to the computing device 300, while in other embodiments the input device 316 is integral to the computing device 300. In some embodiments, the input device 316 communicates with the computing device 300 through the external component interface 314, while in other embodiments, the input device 316 communicates with the computing device 300 through in other interfaces, such as through an interface integrated into a motherboard of the computing device 300.

The external storage device 318 is an external component comprising one or more computer readable data storage media. Different implementations of the computing device 300 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. In some embodiments, the external storage device 318 includes non-transitory media.

The output device 320 is a component that the computing device 300 uses to provide output. Different implementations of the computing device 180 interface with different types of output devices.

The communications medium 322 facilitates communication among the hardware components of the computing device 300. In different embodiments, the communications medium 322 facilitates communication among different components of the computing device 300. For instance, in the example of FIG. 6, the communications medium 322 facilitates communication among the memory 302, the processing unit 304, the secondary storage device 306, the network interface card 308, the video interface 310, and the external component interface 314. In different implementations of the computing device 300, the communications medium 322 is implemented in different ways. For instance, in different implementations of the computing device 300, the communications medium 322 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The memory 302 stores various types of data or software instructions or both. For instance, in the example of FIG. 6, the memory 302 stores a Basic Input/Output System (BIOS) 324, an operating system 326, application software 328, and program data 330. The BIOS 324 includes a set of software instructions that, when executed by the processing unit 304, cause the computing device 300 to boot up. The operating system 326 includes a set of software instructions that, when executed by the processing unit 304, cause the computing device 300 to provide an operating system that coordinates the activities and resources of the computing device 300. Example types of operating systems include, but are not limited to, Microsoft Windows, Linux, Unix, Apple OS X, Apple iOS, Palm webOS, Palm OS, Google Chrome OS, Google Android OS, and so on. The application software 328 includes a set of software instructions that, when executed by the processing unit 304, cause the computing device 300 to provide applications to a user of the computing device 300. The program data 330 is data that the application software 328 generates or uses or both.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A web-based social network system comprising:
a host server having a computer readable storage device storing instructions;
a plurality of terminals, each of the plurality of terminals comprising at least one data input mechanism, a data processing device configured to control the terminal, and a dynamic and interactive graphical user interface;
wherein data associated with members of the social network are stored on the host server and comprise a profile for each member, each profile comprising a geographic location associated with the member;
wherein each of the plurality of terminals is configured to transmit data to and receive data from the host server;
wherein the host server is configured to transmit data to a terminal associated with a first member of the social network;
wherein the processing device of the terminal of the first member executes the instructions and causes the graphical user interface of the terminal of the first member to display an interactive home screen, the interactive home screen comprising an image of a representation of a first portion of the Earth and configured to show at least one of a selectable first marker associated with a first geographic location and at least one of a selectable second marker associated with a second geographic location;
wherein the first marker indicates that the first member is not connected with any members associated with the first geographic location;
and wherein the second marker indicates that the first member is connected with at least one member associated with the second geographic location.

2. The system of claim 1, wherein selection of the first marker enables the first member to connect with members associated with the first geographic location.

3. The system of claim 2, wherein the first marker and the second marker have different graphical configurations.

4. The system of claim 2, wherein the graphical user interface is configured to receive instructions from the at least one data input mechanism to display a representation of a second portion of the Earth on the graphical user interface.

5. The system of claim 4, wherein the representation of the second portion of the Earth is randomly generated.

6. The system of claim 4, wherein the representations of the first portion of the Earth and the second portion of the Earth appear on an image of a globe, and wherein the graphical user interface is configured to receive instructions from the at least one data input mechanism to display a dynamic representation of the globe spinning and then stopping on the representation of the second portion of the Earth.

7. The system of claim 6, wherein the representation of the second portion of the Earth is randomly generated.

8. The system of claim 7, wherein the image of the globe spins at a predetermined speed and for a randomly determined period of time.

9. The system of claim 7, wherein the image of the globe spins at a randomly determined speed and for a randomly determined period of time.

10. The system of claim 9, wherein when the representation of the second portion of the Earth is displayed on the graphical user interface, the graphical user interface is configured to show at least one of the selectable first marker and the selectable second marker associated with one or more geographic locations associated with members of the social network.

11. A computer implemented method for communicating between a first member of a social network and a second member of the social network comprising:
receiving input from the first member selecting a marker displayed on a graphical user interface of a terminal of the first member, wherein the marker is shown on an image of a globe representing at least a portion of the Earth at a position associated with a geographic location;
selecting the second member based on the selected geographic location, the second member having a member profile associated with the selected geographic location;
receiving input from the first member requesting to communicate with the second member;
outputting an invitation to a terminal of the second member requesting the second member to communicate with the first member; and
receiving input from the second member accepting the invitation from the first member.

12. The method of claim 11, wherein the image of the globe graphically indicates every geographic location associated with every member profile of every member of the social network.

13. The method of claim 12, wherein the image of the globe graphically distinguishes between geographic locations associated with member profiles of members of the social network that have agreed to communicate with the first member and geographic locations associated with member profiles of members of the social network that have not agreed to communicate with the first member.

14. A computer implemented method for communicating between a first member of a social network and a second member of the social network comprising:
randomly displaying a first geographic location on an image of a globe representing at least a portion of the Earth, the first geographic location being associated with a member profile of the second member;
selecting the second member based on the first geographic location, the second member having a member profile associated with the first geographic location;
receiving input from the first member requesting to communicate with the second member;
outputting an invitation to a terminal of the second member requesting the second member to communicate with the first member; and
receiving input from the second member accepting the invitation from the first member.

15. The method of claim 14, wherein the image of the globe graphically indicates every geographic location associated with every member profile of every member of the social network; and wherein the first geographic location appears in the center of the globe.

16. The method of claim 14, wherein the globe spins prior to the random displaying of the first geographic location on the image of the globe.
